(19) United States
(12) Patent Application Publication
(10) Pub. No.: US 2011/0128664 A1
(43) Pub. Date: Jun. 2, 2011

(54) Optical Article that Includes an Antistatic Layer Limiting the Perception of Interference Fringes, Having Excellent Light Transmission, and Method of Manufacturing It

(76) Inventors: Peggy Coue, Charenton Le Pont (FR); Mathieu Feuillade, Charenton Le Pont (FR); Elodie Wipf, Charenton Le Pont (FR)

(21) Appl. No.: 13/057,639

(22) PCT Filed: Aug. 4, 2009
(86) PCT No.: PCT/FR09/51557

§ 371 Date: Feb. 7, 2011

(30) Foreign Application Priority Data
Aug. 4, 2008 (FR) 0855401

(51) Int. Cl. H05F 1/00; G02B 1/10; B05D 5/06

(52) U.S. Cl. 361/220; 359/796; 427/162

(57) ABSTRACT

The invention relates to an optical article comprising an organic or mineral glass substrate, a layer of a polymeric material and an intermediate layer possessing antistatic properties in direct contact with a main face of the substrate and the layer of polymeric material, the intermediate layer comprising a mixture of colloidal particles of at least one electrically conductive, colloidal metal oxide, of colloidal particles of at least one colloidal mineral oxide having a refractive index of 1.55 or less and optionally of a binder, in such proportions that the weight of electrically conductive colloidal metal oxide particles represents 50 to 97% of the total weight of colloidal particles present in the intermediate layer, said intermediate layer being an initially porous layer, the porosity of which have been filled either with material of the layer of polymeric material or with material of the substrate if the latter is made of an organic glass, so that the intermediate layer, after the initial porosity thereof has been filled constitutes a quarter-wave layer or an almost quarter-wave layer at the wavelength of 550 nm.

This invention relates to an optical article, for example an ophthalmic lens, comprising a substrate made from a synthetic resin or a mineral glass, having in particular a high refractive index (1.5 or higher, preferably 1.55 or higher), at least one polymeric coating and, interposed between the substrate and said polymeric coating, an antistatic coating that is in addition capable of limiting the perception of interference fringes resulting from the refractive index difference between the substrate and said polymeric coating.

Conventionally, one or more polymeric coatings are formed on the main sides of a transparent substrate made from a synthetic resin or a mineral glass, such as an ophthalmic lens, in order to impart to the item several advantageous properties such as impact resistance, abrasion resistance, reflection removal, etc.

Thus, generally, at least one side of the substrate is coated either directly with an abrasion resistant layer, or with a primer layer, generally a layer for improving the impact resistance of the lens, onto which an abrasion resistant layer may be applied, the primer layer improving the anchoring of such an abrasion resistant layer on the substrate's surface. Finally, other coatings may further be deposited onto the abrasion resistant layer, such as an anti-reflection coating.

Nowadays, in order to form the abrasion resistant coating and primer layers, varnishes are used, i.e., compositions leading to a largely organic material as opposed to layers with an essentially mineral nature such as metal oxide and/or silicon oxide layers.

Generally, the substrate and the abrasion resistant layer or the primer layer have different refractive indices that are often very distant from each other and as a result, an interference fringe phenomenon appears due to the difference in the refractive indices at the interface between the substrate and the abrasion resistant layer or the primer layer.

This problematic interference fringe phenomenon may be solved by matching the refractive indices of the substrate and of the coating layer in contact therewith, which is relatively cumbersome.

It has also been proposed in the patent application WO 03/056366, in the name of the applicant, to solve such problem by inserting between the substrate and the polymeric layer an initially porous quarter-wave layer based on colloidal mineral oxide particles, the porosity of which has been at least partially filled, generally totally or almost totally filled, with the material of the polymeric layer or the material of the substrate, when this one is polymeric in nature. Such structure efficiently reduces the interference fringe intensity.

Moreover it is well known that optical articles, made from substantially insulating materials, have a tendency to build up static electricity charges onto their surface, especially when cleaned under dry conditions by rubbing the surface thereof using a wiping cloth, a piece of synthetic foam or polyester (triboelectricity). Charges that are present on the surface generate an electrostatic field capable of drawing and fixing very low weight-elements that are close at hand (few centimeters), generally small-sized particles such as dust, and this lasts as long as the charge remains on the article.

To reduce or prevent such particle attraction, the electrostatic field intensity should be decreased, that is to say the number of static charges present on the article's surface should be reduced. This may be obtained by making the charges mobile, for example by introducing a layer made of a material inducing amongst the “charge carriers” a high mobility, so as to disperse them rapidly. Materials inducing the highest mobility are conductive materials.

The state of the art reveals that an optical article may acquire antistatic properties by incorporating onto its surface, within the functional coating stack, at least one electrically conductive layer, that is said to be an “antistatic layer.” Such antistatic layer may constitute the functional coating stack outer layer, an intermediate layer (inner layer) or may be deposited directly onto the substrate of the optical article. Providing such a layer in a stack imparts antistatic properties to the article, even if the antistatic coating is interleaved between two non-antistatic coatings or substrates.

As used herein, “antistatic” is defined as the ability to retain and/or to develop a substantial electrostatic charge. An article is generally considered as possessing acceptable antistatic properties insofar as it does neither draw nor fix dust or small particles after one of its surfaces has been rubbed using a suitable wiping cloth. It may quickly disperse any accumulated electrostatic charge, whereas a static article just having been rubbed can draw the surrounding dust all the time it remains charged.

The ability for a glass to disperse a static charge resulting from the rubbing using a cloth or any other suitable method for generating an electrostatic charge (through corona discharge, . . . ) may be quantified by measuring the time necessary for said charge to be dispersed. Thus, antistatic glasses have a discharge time of about a hundred of milliseconds, whereas it is of about several tens of seconds for a static glass, sometimes even of several minutes.

In the present application, an optical article is considered as being antistatic when its discharge time is lower than a few hundreds ms, typically <200 ms, whatever the amount of applied charge (typically, for a test, the charge may vary from 20 to 50 nanocoulons, which, as a rule, does correspond to the amounts actually obtained through the triboelectric effect due to rubbing).

Known antistatic coatings comprise at least one antistatic agent, which is generally an optionally doped (semi-)conductive metal oxide, such as tin-doped indium oxide (ITO), antimony-doped tin oxide, vanadium pentoxide, or a conjugated structure-conductive polymer.

The patent U.S. Pat. No. 6,852,406 describes optical articles, especially ophthalmic lenses, provided with an anti-reflection stack which is mineral in nature comprising a transparent, tin-indium oxide—(ITO) or tin oxide-based, antistatic layer, mineral in nature, deposited under vacuum. Such conception is relatively cumbersome because it does not allow to make an antistatic optical article devoid of any anti-reflection coating.

More advantageously, optical articles will be provided, wherein the antistatic layer is independent from the anti-reflection stack.

A number of patent applications (US 2004/0209007, US 2002/0114960 . . . ) describe articles provided with an antistatic layer based on conductive polymers deposited directly onto the substrate of the article and independent from the anti-reflection coating.

The Japanese application JP 2006-095997 describes an optical article onto which have been deposited in this order, a 30 nm to 1 micrometer-thick antistatic layer comprising conductive particles of from 50 to 60 nm diameter agglomerated to 0.8 to 2 pm-sized secondary particles (for example ITO particles) and a resin, thereafter an anti-abrasion hard layer. By suitably controlling the conductive particle sizes, it is possible to prevent the formation of interference fringes resulting from the refractive index difference that exists between the antistatic layer and the substrate. This document therefore does not aim at solving the problem of interference fringes between the substrate and the anti-abrasion coating by means of a quarter-wave intermediate layer.

To date, it has thus not been described any coating possessing antistatic properties and simultaneously capable of removing interference fringes by using an intermediate layer the refractive index of which is chosen in relation to the refractive indices of the materials provided on both sides of this coating, with the view of forming a quarter-wave layer, in particular by using a suitable ratio between a conductive colloid and a low refractive index colloid contained within the antistatic layer.

It is thus an object of the present invention to provide an optical article, such as an ophthalmic lens, comprising an organic or mineral glass substrate and at least one layer of a transparent, polymeric material, such as, for example, a primer layer or a layer of an anti-abrasion coating, wherein the interference fringe phenomenon resulting from the refractive index difference between the substrate and said layer of polymeric material is substantially attenuated, and which does at the same time possess antistatic properties.

The higher the index difference (measured at 550 nm) between the substrate and the layer of a transparent, polymeric material will be, typically of at least 0.01, preferably at least 0.02, more preferably at least 0.05, and even more preferably at least 0.1, the more difficult the technical problem to deal with.

It is also an object of the present invention to provide an optical article having antistatic properties and an excellent light transmission level within the visible spectrum.

By introducing an antistatic layer that generally induces a transmission decrease because of its absorbing ability, it is indeed especially interesting to counterbalance such transmission loss by using an antistatic quarter-wave layer.

It is a further object of the present invention to provide an optical article that is temporarily stable and in particular that withstands photodegradation.

It is still another object of the present invention to provide a method of manufacturing an optical article such as defined hereabove, being easily integrated into the conventional manufacturing method and which, more particularly, prevents as much as possible implementing vacuum coating or any other processing step being a break in optical article manufacturing method.

The above-mentioned objectives are aimed at according to the invention with an optical article, for example, an ophthalmic lens and more particularly a spectacle lens, comprising an organic or mineral glass substrate, a layer of a polymeric material and an intermediate layer possessing antistatic properties in direct contact with a main face of the substrate and the layer of polymeric material, the intermediate layer comprising a mixture of colloidal particles of at least one electrically conductive colloidal metal oxide, of colloidal particles having a refractive index of 1.55 or less, and optionally of a binder, in such proportions that the weight of electrically conductive colloidal metal oxide particles represents 50 to 97%, preferably 55 to 95%, more preferably 60 to 95%, and even more preferably 60 to 90% of the total weight of colloidal particles present in the intermediate layer, said intermediate layer being an initially porous layer, the porosity of which has been filled either with material of the layer of polymeric material or with material of the substrate if the latter is made of an organic glass, so that the intermediate layer, after the initial porosity thereof has been filled, verifies the characteristics given by the following relationships:

$$\begin{matrix}0.725 \times \frac{λ}{4 n} \leq e \leq 1.35 \times \frac{λ}{4 n} & ( 1 ) \\ 0.98 \times \sqrt{{n}_{substrate} \cdot {n}_{polymer}} \leq n \leq 1.02 \times \sqrt{{n}_{substrate} \cdot {n}_{polymer}} & ( 2 )\end{matrix}$$

wherein n is the refractive index of the intermediate layer, n_{substrate} is the refractive index of the substrate, n_{polymer} is the refractive index of the layer of polymeric material directly contacting the intermediate layer, e is the thickness of the intermediate layer and λ is set at 550 nm.

In the present application and unless otherwise specified, the refractive indices are defined at a temperature of 25° C. and for a wavelength of 550 nm, which is the wavelength corresponding to the maximal sensitiveness of the human eye, and at which one does thus mainly wish to remove the interference fringes.

The maximum attenuation in the perception of interference fringes may be found at 550 nm, or at another wavelength within the visible range, depending on the n and e values applicable for calculating the hereabove equations (1) and (2).

The inventors found that the perception of interference fringes was attenuated when values were used for n and e as defined in equations (1) and (2).

The present invention also relates to a method for making an optical article such as previously defined, comprising:

a) depositing a layer of an intermediate layer composition either on at least one main surface of an organic or mineral glass substrate, or on a layer of a polymeric material, said composition comprising a mixture of colloidal particles of at least one electrically conductive, colloidal metal oxide, of colloidal particles having a refractive index of 1.55 or less and optionally of a binder;

b) drying the intermediate layer composition so as to form an initially porous intermediate layer;

c) forming onto this porous intermediate layer either a layer of a polymeric material, or an organic glass substrate, so that the initial porosity of the intermediate layer be filled either with material of the polymeric layer, or with material of the substrate if the latter is made of an organic glass, and so that the intermediate layer, after the initial porosity thereof has been filled, verifies the hereabove equations (1) and (2);

d) recovering an optical article comprising an intermediate layer having antistatic properties in direct contact with a main surface of the substrate and the layer of polymeric material, the weight of electrically conductive colloidal metal oxide particles representing 50 to 97% of the total weight of colloidal particles present in the intermediate layer.

From the moment when the refractive indices of the substrate of the layer of polymeric material are known, the hereabove equations (1) and (2) enable to determine the thickness and refractive index ranges e and n, respectively, of the intermediate layer of the invention.

As previously mentioned, the thickness and refractive index characteristics of an intermediate layer of the invention may deviate from the quarter-wave layer optimum theoretical values. This will be then in the present application referred to as an almost quarter-wave layer.

When the hereabove equations (1) and (2) are satisfied, a satisfactory anti-interference fringe effect is obtained. Preferably, the intermediate layer verifies the following equation:

$$0.85 \times \frac{λ}{4 n} \leq e \leq 1.15 \times \frac{λ}{4 n} . \qquad ( {1}^{″} )$$

and even more preferably:

$$0.8 \times \frac{λ}{4 n} \leq e \leq 1.2 \times \frac{λ}{4 n} , \qquad ( {1}^{′} )$$

In practice, it may be difficult to measure the thickness of the intermediate layer after the pores thereof have been filled with the polymeric material or with the material of the substrate. As a first approximation, this thickness may be considered as being equal to that of the deposited colloidal particle layer once dry, since the thickness thereof does not vary much as a result of the diffusion of the porous layer filling material.

Preferably, the intermediate layer verifies the following equation:

0.985×\sqrt{n_{substrate}·n_{polymer}}≦n≦1.015×\sqrt{n_{substrate}·n_{polymer}} (2′),

and even more preferably:

0.99×\sqrt{n_{substrate}·n_{polymer}}≦n≦1.01×\sqrt{n_{substrate}·n_{polymer}} (2″)

In practice, it may be difficult to measure the refractive index of the intermediate layer after the porosity thereof has been filled with the polymeric material or with the material of the substrate. As a first approximation, this refractive index may be considered as being equal to the theoretical refractive index of an intermediate layer, the pores of which would have been totally filled with the filling material. A method for calculating this theoretical refractive index is indicated in the experimental section, where it is noted n₃.

An intermediate layer of the invention may also form a quarter-wave layer as such at the wavelength of 550 nm. It is the most preferred embodiment. In the latter case, its refractive index n and the thickness thereof e are equal to the theoretical refractive index and thickness of a quarter-wave layer, that is to say they verify the following relations:

$$e = \frac{λ}{4 n} and n = \sqrt{{n}_{substrate} \cdot {n}_{polymer}}$$

wherein λ, n_{substrate} and n_{polymer} are as previously defined. In other words, the refractive index n of the quarter-wave layer corresponds to the geometric mean of the refractive indices of the materials surrounding it.

According to the present invention, determining the optimal refractive index and the optimal thickness of an intermediate layer to be interposed between a substrate and a polymeric layer of predefined refractive indices is not a free choice because both parameters depend on the refractive indices of the substrate and of the polymeric layer. On the contrary, the nature of the colloids forming the layer is more unconstrained. An intermediate layer of the invention, that is to say a layer possessing the refractive index and thickness characteristics of a quarter-wave layer or similar to those of a quarter-wave layer and possessing simultaneously sufficient antistatic properties will be obtained by suitably selecting the nature of the conductive particle colloid(s) and of the low refractive index particle colloid(s), as well as their respective amounts. The person skilled in the art perfectly knows how to obtain the appropriate formulation without conducting an excessive number of experiments.

Until now, only mineral antistatic layers comprising exclusively conductive metal oxides such as ITO and optionally a binder had been described. Antistatic layers comprising in addition non conductive mineral oxide particles were unknown.

The person skilled in the art may also change the refractive index of the intermediate layer by taking advantage of the presence of a binder and the nature thereof, of the diameter of the colloidal particles influencing the initial pores of the intermediate layer, or of the nature of the filling material for the initial porosity of the colloid intermediate layer, which may be either material of the polymeric layer, or material of the substrate.

Thus, when antistatic properties of a quarter-wave layer or an almost quarter-wave layer obtained from a given mixture of conductive particles and low refractive index-particles are not sufficient, the person skilled in the art may easily prepare a layer having similar thickness and refractive index by increasing the amount of conductive particles relative to low refractive index-particles, without modifying the nature of the conductive particles, but by replacing the low refractive index particles with other particles possessing a lower refractive index.

While remaining within the thickness range allowed according to the present invention, that is to say the range given by equation (1) relating to the theoretical thickness of a quarter-wave layer at 550 nm, it is also generally possible to increase the thickness of the intermediate layer to improve the antistatic properties thereof.

When the antistatic properties of a layer obtained from a given mixture of conductive particles and low refractive index-particles are sufficient, but this layer has a high refractive index to the point it cannot prevent the fringe phenomenon and so be included in the scope of the invention, the person skilled in the art may prepare a quarter-wave layer or an almost quarter-wave layer by replacing the low refractive index particles with other particles possessing a lower refractive index.

It is indeed more convenient to adjust or to regulate the refractive index of the intermediate layer by modifying the nature of the low refractive index-particles, the conductive particles having generally a refractive index within the limited range of from about 1.9 to 2.

Therefore it may in some cases be advantageous to use hollow colloidal particles, in particular of colloidal mineral oxide with a low refractive index, of the core/shell structure type, the core of the particle being devoid of material (filled with air) or porous colloidal particles, for example having a small-sized pores network as compared to the particle size, providing a large range of refractive indices since the latter may typically vary of from 1.15 to 1.45. These particles have a lower refractive index as compared to the same non hollow or non porous particles because the air contained within the hollow volume or within the pores of these particles has a lower refractive index as compared to the material from which they are made. They will be described in detail hereunder.

The intermediate layer may be formed onto an organic or mineral glass substrate, preferably an organic glass substrate, such as a preformed ophthalmic lens. That is a polymeric material in this case, which ensures the filling of the pores of the intermediate layer. Such a method may imply transferring or applying one or more coatings onto the substrate coated with the porous intermediate layer.

It may also be formed onto a portion of a mould a main moulding surface of which is coated with at least one coating forming the layer of polymeric material, that is preferably optically transparent. In this embodiment, the substrate is made of an organic glass (i.e. polymeric in nature) and may be formed in situ upon cast transfer of a liquid polymerizable composition in the mould provided onto one surface thereof with the coating forming the layer of polymeric material coated with the porous intermediate layer, followed with a polymerization. That is the substrate material which then ensures the porosity filling in the intermediate layer.

For a more detailed description of the various methods for preparing an intermediate layer according to the invention by filling the initial pores thereof using a polymeric material, see the description of the application WO 03/056366 in the name of the applicant as well as the appended FIGS. 5 to 7, which is incorporated herein as a reference thereto.

Substrates that are suitably used for the articles of the present invention may be any optically transparent substrate made from mineral or organic glass, preferably organic glass substrates.

The plastic materials appropriate for such substrates include the homo- and copolymers of carbonate, (meth)acrylics, thio(meth)acrylics, diethylene glycol bisallylcarbonate such as the material CR39® marketed by PPG, urethane, thiourethane, epoxide, episulfide and the combinations thereof.

The preferred materials for the substrates are polycarbonates (PC), polyurethanes (PU), polythiourethanes, (meth)acrylic and thio(meth)acrylic polymers.

Generally, the substrates have a refractive index ranging from 1.55 to 1.80 and preferably from 1.60 to 1.75.

When the intermediate layer composition has to be deposited onto an already formed substrate, the surface of the bare substrate made from an organic or mineral glass, for example an ophthalmic lens, may beforehand be treated through dipping into a 5% soda solution under heat, for example at 50° C. (3 minutes), followed by water and isopropanol rinsing.

According to the invention, the intermediate layer is obtained from an intermediate layer composition comprising colloidal particles of at least one colloidal mineral oxide having a refractive index of 1.55 or less, colloidal particles of at least one electrically conductive, colloidal metal oxide, and optionally a binder.

Use of a certain amount of colloidal particles having a refractive index of 1.55 or less is necessary, since the refractive index of a layer comprising only conductive metal oxide particles having a refractive index close to 2, the pores of which have been filled with a material, is necessarily higher than that of the material itself. Such a layer therefore could not be used as a quarter-wave layer or almost quarter-wave layer.

Colloidal particle preparation requires well known methods. As used herein, “colloids” mean fine particles the diameter of which (or the largest size of which) is less than 1 pm, preferably less than 150 nm, more preferably less than 100 nm, dispersed within a dispersing medium such as water, an alcohol, a ketone, an ester or combinations thereof, preferably an alcohol such as ethanol or isopropanol. Preferred colloidal particle diameters range from 10 to 80 nm, from 30 to 80 nm and from 30 to 60 nm.

In particular, colloidal particles, preferably particles of colloidal mineral oxide may be made of a mixture of small sized-particles, for example from 10 to 15 nm and of larger sized- particles, for example from 30 to 80 nm.

Colloidal particles may also be fluorides with a low refractive index such as Mg F₂, ZrF₄, AIF₃, chiolite (Na₃[Al₃F₁₄]), and cryolite (Na₃[AlF₆]).

In the remainder of the present description, colloidal particles, in particular particles of a colloidal mineral oxide having a refractive index of 1.55 or less, preferably of 1.50 or less, will be typically called, respectively colloidal particles with a low refractive index and colloidal mineral oxide “with a low refractive index.” Their refractive index is preferably of 1.15 or more.

Oxide colloidal particles with a low refractive index may be, without limitation, silica particles, alumina-doped silica particles, mineral oxide particles, which are said to be hollow or porous, as defined hereabove, or combinations thereof. As a rule, they are non electrically conductive particles.

Examples of colloidal silicas to be suitably used include those silicas prepared by the Stöber method. The Stöber method is a simple and well known method comprising a hydrolysis and condensation of the ethyl tetrasilicate Si(OC₂H₅)₄ in ethanol catalyzed by ammonia. The method allows to obtain a silica directly in ethanol, a quasi monodispersed particle population, a controllable particle size and a particle surface (SiO⁻NH₄⁺). Silica colloids are also marketed by DuPont de Nemours under the commercial name LUDOX®.

Mineral oxide particles which are said to be hollow or porous, their use in optics and the methods for preparing the same, have been extensively described in the literature, in particular in the patent applications WO 2006/095469, JP 2001-233611, WO 00/37359, JP2003-222703. Such particles are also commercially available from the Catalysts & Chemicals Industries Co. (CCIC), for example in the form of porous silica sols under the trade name THRULYA®.

These particles may be modified by grafting an organic group, especially onto a silicon atom, or may be composite particles based on several mineral oxides.

In the present invention, preferred particles of colloidal mineral oxide with a low refractive index are hollow or porous particles possessing a refractive index preferably ranging from 1.15 to 1.40, more preferably from 1.20 to 1.40, and with a diameter preferably ranging from 20 to 150 nm, more preferably from 30 to 100 nm. Most preferred are silica hollow particles.

As used herein, an electrically conductive metal oxide means an optionally doped, conductive or semi-conductive metal oxide. Electrically conductive metal oxides generally have a high refractive index, of about 1.9 to 2.0.

Non limitative examples of electrically conductive metal oxides include tin-doped indium oxide (ITO), antimony-doped tin oxide (ATO), aluminium-doped zinc oxide, tin oxide (SnO₂), zinc oxide (ZnO), indium oxide (In₂O₃), vanadium pentoxide, antimony oxide, cerium oxide, zinc antimonate, indium antimonate. The last two compounds and the method for preparing the same are described in the patent U.S. Pat. No. 6,211,274.

Most preferred are tin-doped indium oxide and tin oxide. In one most preferred embodiment, the intermediate layer comprises only one electrically conductive metal oxide, i.e. tin-doped indium oxide (ITO).

The intermediate layer composition may comprise other categories of colloidal particles, in particular non electrically conductive particles having a refractive index of more than 1.55, provided their presence does not interfere with the provision of antistatic properties and of an anti-interference fringe effect. Non limiting examples of such particles include TiO₂, ZrO₂, Sb₂O₃, Al₂O₃, Y₂O₃, Ta₂O₅ and combinations thereof. Composites such as SiO₂/TiO₂, SiO₂/ZrO₂, SiO₂/TiO₂/ZrO₂, or TiO₂/SiO₂/ZrO₂/SnO₂ may also be employed.

The intermediate layer composition preferably comprises a binary mixture of an oxide with a low refractive index and of an electrically conductive oxide.

According to the present invention, the weight of electrically conductive colloidal metal oxide particles represents from 50 to 97%, preferably from 55 to 95%, more preferably from 60 to 95% and even more preferably from 60 to 90% of the colloidal particle total weight, preferably of the colloidal oxides that are present in the intermediate layer. Preferably, these proportions are also fulfilled in the intermediate layer composition. Such electrically conductive particle amounts are intended to ensure antistatic properties sufficient for the intermediate layer, which should reach the conductivity threshold.

The intermediate layer composition may optionally comprise at least one binder, in such an amount that prior to filling the initial pores of the deposited and dried layer of colloids, said porous layer comprises preferably from 1 to 30% by weight of binders based on the total (dry) weight of colloidal particles present in this layer, more preferably from 10 to 25% and even more preferably from 10 to 20%.

The binder is generally a polymeric material, the influence of which is not detrimental to the optical properties of the final intermediate layer and which improves cohesion and adhesion of oxide particles onto the substrate's surface. It may be formed from a thermoplastic or thermosetting material, optionally crosslinkable through polycondensation, polyaddition or hydrolysis. Mixtures of binders derived from various categories may also be employed.

Examples of binders to be suitably used are given in the application WO 2008/015364, in the name of the applicant. To be more especially mentioned amongst all of them are polyurethane, epoxy, melamine, polyolefin, urethane acrylate, and epoxyacrylate type resins, and those binders obtained from monomers such as methacrylate, acrylate, epoxy, and vinyl monomers. Preferred binders are organic in nature and include especially polyurethane latexes and (meth)acrylic latexes, very especially polyurethane type latexes.

In a preferred embodiment of the invention, the intermediate coating composition does not comprise any binder.

Preferably, the solids content of the intermediate layer composition accounts for less than 15% of the total weight of said composition, more preferably for less than 10% and even more preferably for less than 5%.

The thickness of an intermediate layer of the invention does typically vary from 50 to 130 nm, preferably from 60 to 130 nm, more preferably from 75 to 110 nm, and even more preferably from 80 to 100 nm, where this thickness of course should be in conformity with the range of equation (1) and allow the provision of antistatic properties. This thickness is the one obtained after the filling of the initial pores of the intermediate layer, and is generally virtually the same as the thickness prior to filling.

Generally, increasing the thickness of the intermediate layer, that is to say increasing the amount of deposited conductive particles, improves the antistatic properties thereof.

For an optimal interference fringe attenuation, the thickness of an intermediate layer should be of course as close to the theoretical thickness of a quarter-wave layer as possible, considering the materials used for the optical article.

Typically, the initial pores of the intermediate layer, in the absence of any binder, represent at least 20% by volume, of the intermediate layer total volume, and preferably at least 30% by volume, more preferably at least 40% by volume. This porosity (prior to filling) corresponds to the porosity obtained after deposition and drying of the intermediate layer composition.

As used herein, “initial porosity” mean the pores which are inherently generated through stacking of the oxide colloidal particles of the intermediate layer composition deposited and dried. This initial porosity is an accessible, open porosity, which is exclusively capable of being filled with the polymeric material or with the material of the substrate. If hollow colloidal oxides are employed in the intermediate layer composition, the initial porosity thus does not comprise the pores of these hollow oxides, unattainable to the polymeric material or to the material of the substrate.

When the intermediate layer comprises a binder, the initial porosity of this layer corresponds to the residual porosity considering the volume occupied by the binder, but prior to filling with the filling material made from the material of the subsequent layer or the substrate. It represents preferably at least 20%, more preferably at least 30% by volume of the intermediate layer total volume.

The colloidal intermediate layer composition is preferably deposited onto the substrate or, depending on the situation, onto the layer of polymeric material, by dip coating. It may also be deposited by spin coating. Typically, the support onto which the deposition is conducted is dipped into the liquid intermediate layer composition, the thickness deposited depending on the solids content of the sol, on the particle size and on the dewetting rate (Landau-Levich law).

Thus, when the coating composition, the particle size, the refractive indices of the substrate and of the coating of polymeric nature are known, the intermediate layer desired thickness and the dewetting rate required for the expected thickness can be determined.

After drying of the deposited layer, a porous colloidal oxide layer is obtained with the expected thickness. Drying of the layer may be carried out at a temperature ranging from 20 to 130° C., preferably from 20° C. to 120° C., more preferably at room temperature (20-25° C.).

The layer of polymeric material used in the present invention preferably has a surface energy higher than or equal to 20 milliJoule/m², preferably higher than or equal to 25 milliJoule/m² and more preferably, higher than or equal to 30 milliJoule/m².

The surface force energy is calculated according to the Owens-Wendt method described in the following reference: “Estimation of the surface force energy of polymers” Owens D. K., Wendt R. G. (1969), J. APPL. POLYM. SCI., 13, 1741-1747.

The polymeric material is essentially described in the context of the embodiment according to which it is used as a filling material for the porosity of the intermediate layer. However, the following description also applies when the material of the substrate is used as a filling material.

The composition leading to the filling polymeric material comprises essentially one (or more) non fluorinated compound(s).

Preferably, the composition leading to the filling polymeric material comprises at least 80% of non fluorinated compounds based on the total weight of the compounds forming the solids content of said composition, more preferably at least 90% by weight, even more preferably at least 95% by weight and most preferably 100% by weight. As used herein, the solids content means the solid materials that remain once solvents have been evaporated under vacuum at a temperature up to 100° C.

Typically, the fluorine level in the filling polymeric material is lower than 5% by weight, preferably lower than 1% by weight and more preferably is 0% by weight.

The porosity (by volume) of the intermediate layer after filling is preferably lower than any one of following values: 20%, 10%, 5%, 3%, and even more preferably is 0%. As for the previously defined initial porosity, porosity after filling does not consider the “closed porosity” of the optionally used hollow oxide colloidal particles. Thus, an intermediate layer which initial pores have been fully filled will have according to the present invention no porosity, even if it comprises hollow colloidal oxide particles.

The filling material used in the present application may be in the form of monomers, oligomers, polymers or combinations thereof.

After filling, the filling material contacts the substrate surface (when the filling material is not that of the substrate but that of another layer such as the primer or antiabrasion layer) and makes it possible to obtain the adhesion of the intermediate layer onto the substrate.

The layer of polymeric material ensuring the filling of the initial porosity of the intermediate layer is generally formed by dip coating or by spin coating, preferably by dip coating.

The layer of polymeric material in direct contact with the intermediate layer is preferably a layer of a transparent material. It may be a layer of a functional material, for example a layer of an adhesion primer coating and/or impact-resistant primer coating, a layer of an anti-abrasion coating and/or scratch-resistant coating or a layer of an anti-reflection coating. It may also be a layer of an adhesive composition. The layer of polymeric material according to the invention is preferably a primer layer.

Such primer layer may be any primer layer traditionally used in the optical field and in particular in the ophthalmic field.

Typically, these primers, in particular impact-resistant primers, are coatings based on (meth)acrylic polymers, polyurethanes, polyester, or based on epoxy/(meth)acrylate copolymers.

Impact-resistant coatings based on (meth)acrylic polymers are described amongst others in the patents U.S. Pat. No. 5,015,523 and U.S. Pat. No. 5,619,288, whereas coatings based on crosslinked, thermoplastic polyurethane resins are described, amongst others, in the Japanese patents 63-1411001 and 63-87223, in the European patent EP-040411 and the American patent U.S. Pat. No. 5,316,791.

In particular, the impact-resistant primer coating of the invention may be made from a poly(meth)acrylic latex, including of the core-shell type such as described, for example, in the French patent application FR 2.790.317, from a polyurethane latex or from a polyester latex.

Especially preferred impact-resistant primer coating compositions include the acrylic latex marketed under the trade name A-639 by the Zeneca company and polyurethane latexes marketed under the trade names W-240 and W-234 by the Baxenden company.

Latexes will be preferably selected with a particle size 50 nm and more preferably 20 nm.

Generally, after hardening, the impact-resistant primer layer has a thickness ranging from 0.05 to 20 μm, preferably from 0.5 to 10 μm and more preferably from 0.6 to 6 μm. The optimal thickness generally ranges from 0.5 to 2 μm.

The anti-abrasion coating may be any anti-abrasion coating traditionally used in the optical field and, more particularly, in ophthalmic optics.

By definition, an anti-abrasion coating is a coating improving the abrasion resistance of the finished optical article as compared to a similar article which does not comprise the anti-abrasion coating.

The preferred anti-abrasion coatings are those obtained through hardening of a composition containing one ore more alkoxysilane(s) (preferably one or more epoxyalkoxysilane(s)) or a hydrolyzate thereof and preferably a mineral colloidal filler, such as a colloidal oxide filler.

According to a particular aspect, preferred anti-abrasion coatings are those obtained through hardening of a composition comprising one or more epoxyalkoxysilanes or a hydrolyzate thereof, silica and a hardening catalyst. Examples of such compositions are disclosed in the International Application WO 94/10230 and the U.S. Pat. Nos. 4,211,823, 5,015,523 as well as the European Patent 614,957.

The particularly preferred anti-abrasion coating compositions are those comprising as main constituents an epoxyalkoxysilane such as, for example, the γ-glycidoxypropyltrimethoxysilane (GLYMO), a dialkyl-dialkoxysilane, such as, for example, the dimethyldiethoxysilane (DMDES), a colloidal silica and a catalytic amount of a hardening catalyst such as aluminum acetylacetonate or a hydrolyzate of such constituents, the balance of the composition essentially consisting in solvents conventionally used for formulating such compositions and optionally one or more surfactants.

In order to improve the anti-abrasion coating adhesion, the anti-abrasion coating composition may optionally comprise an effective amount of a coupling agent, more particularly, when the coated substrate is made using the in-mould casting technology or IMC.

Such a coupling agent is typically a pre-condensed solution of an epoxyalkoxysilane and an unsaturated alkoxysilane, preferably comprising a terminal double ethylene bonding. These compounds are described in detail in the application WO 03/056366 in the name of the applicant. Typically, the amount of coupling agent introduced into the anti-abrasion coating composition accounts for 0.1 to 15% by weight of the total weight of the composition, preferably from 1 to 10% by weight.

The anti-abrasion coating thickness, after hardening, usually ranges from 1 to 15 μm, preferably from 2 to 6 μm.

Polymeric material compositions such as impact-resistant primer compositions and anti-abrasion coating compositions may be hardened thermally and/or through irradiation, preferably thermally.

Most obviously, as previously indicated, the material of the primer layer or of the anti-abrasion coating layer should penetrate into and at least partially fill the porosity of the intermediate layer when this material is used as a filling material.

The optical article according to the invention may optionally comprise an anti-reflection coating preferably formed on the anti-abrasion coating layer.

The anti-reflection coating may be any anti-reflection coating traditionally used in the optical field, in particular in ophthalmic optics.

By way of example, the anti-reflection coating may consist in a mono- or multilayer film, dielectric materials such as SiO, SiO₂, Si₃N₄, TiO₂, ZrO₂, Al₂O₃, MgF₂ or Ta₂O₅ or mixtures thereof. It is thereby possible to prevent a reflection from occurring at the lens-air interface.

Such an anti-reflection coating is generally applied through vacuum coating, especially through evaporation, optionally ionic beam assisted, through vaporization by ion beam, through sputtering, or through plasma assisted chemical vapor deposition.

Besides to the vacuum coating, it can also be contemplated to apply a mineral layer through a wet sol-gel route by using a liquid composition comprising a silane hydrolyzate and colloidal materials with high (>1.55) or low (≦1.55) refractive indices. Such a coating which layers comprise a hybrid organic/inorganic matrix based on silanes within which colloidal materials are dispersed to adjust the refractive index of each layer are described for example in the patent FR 2858420. This category of composition may be employed for forming the layer of polymeric material according to the present invention, and particularly as a filling material for the initial porosity of the intermediate layer.

In the case where the anti-reflection coating comprises one single layer, the optical thickness thereof should be preferably equal to λ/4 (λ is a wavelength ranging from 450 to 650 nm).

In the case of a multi-layer film comprising three layers, a combination may be used, corresponding to respective optical thicknesses of either λ/4, λ/2, λ4 or λ/4, λ/4, λ/4. An equivalent film can moreover be used, formed by more layers, instead of any number of layers being part of the three above-mentioned layers.

Some particular embodiments of the method according to the invention will be described now.

The layer of polymeric material filling the initial porosity of the intermediate layer may be a layer of an adhesive composition. This embodiment, which is described in detail in the application WO 03/056366 in the name of the applicant, in particular on FIG. 6 of such application, may be adapted to the present invention and will be only summarized hereafter.

In this embodiment, an optical article that includes an antistatic and anti-interference fringe layer is obtained by transferring a coating or a stack of coatings onto a preform or a substrate coated with a dried porous colloidal layer according to the invention, which comprises optionally a binder.

On a surface of a preferably flexible mould (or support), a monolayer or multilayer stack is formed, for example, in following order, an anti-reflection coating, an anti-abrasion and/or scratch-resistant hard coating layer, and a primer layer. Preferably, the anti-reflection coating, anti-abrasion and/or scratch-resistant and primer layers are dried and/or hardened, at least partially.

A suitable amount of an adhesive material is then deposited, either onto the porous intermediate layer, or onto the outer surface of the multilayer stack, that is to say the primer layer in the hereabove example, but preferably onto the porous intermediate layer, thereafter the substrate provided with the porous intermediate layer is pressed against the whole monolayer or multilayer coating carried by the mould. The adhesive composition may also be injected between the intermediate layer and the stack carried by the mould.

Once the adhesive composition has been hardened, the mould is removed for obtaining an optical article according to the invention.

In this embodiment, the initial pores of the intermediate layer are filled with the adhesive composition which forms the layer of polymeric material in direct contact with the intermediate layer. This adhesive layer ensures the adhesion of the monolayer or multilayer stack to the intermediate layer, that is itself bound to the substrate.

Preferably, the adhesive composition is a radiation-hardenable organic material, for example, through UV radiation. It may optionally have impact-resistant properties. Examples of such materials are described in the patent U.S. Pat. No. 5,619,288.

The thus formed intermediate layer of the invention limits or removes the interference fringes, especially when the refractive index difference between the substrate and the material forming the adhesive composition is high.

In another embodiment of the invention, the filling of the initial pores of the intermediate layer is ensured by the material of the substrate. This embodiment, which is described in detail in the application WO 03/056366 in the name of the applicant, in particular on FIG. 7 of said application, may be adapted to the present invention. It will be only summarized hereafter and uses preferably a so called In Mold Coating type method (IMC).

On a suitable portion of a first part of a two-part mould that is traditionally used for manufacturing an ophthalmic lens, a monolayer or multilayer stack is formed, for example, in following order, an anti-fouling layer, an anti-reflection coating, an anti-abrasion and/or scratch-resistant hard coating layer, and a primer layer. Thereafter, onto the outer surface of the multilayer stack, that is to say the primer layer in the hereabove example, preferably through spin coating or dip coating, a colloidal oxide intermediate layer is formed which thickness and porosity values are as required according to the invention.

Once the two parts of the mould have been assembled by means of an adhesive seal, a composition of liquid monomers is injected into the mould cavity, which upon hardening will form the substrate. An optical article according to the invention is obtained after extraction out of the mould.

Preferably, the optical article of the invention does not absorb in the visible range or only absorbs few in the visible range, which means, according to the present application, that the luminous transmittance thereof (Tv factor) is higher than 85%, more preferably higher than 90% and even more preferably higher than 91%. The experimental section shows that this transparency characteristic is obtained despite the presence of conductive metal particles in the intermediate layer, by selecting a suitable thickness for these particles in a suitable amount.

The transmittance factor Tv is such as defined in the international standard IS013666 (1998) and is measured in accordance with the standard IS08980-3. It is defined within the wavelength range of from 380 to 780 nm.

The following examples are given to illustrate the invention in more detail without restricting it.

### EXPERIMENTAL SECTION

### 1) Methods

### a) Evaluation of Discharge Time

Discharge times of the optical articles have been measured at room temperature (25° C.) by means of a discharge time measuring device JCI 155 (John Chubb

Instrumentation) by following the manufacturer specifications, after having submitted said optical articles to a corona discharge of −9000 volts for 30 ms.

During these experiments for measuring the charge and the discharge of the surface of a glass submitted to a corona discharge treatment, the two following parameters have been determined: the maximum voltage measured at the glass surface, written Uₘₐₓ, and the time required to reach 1/e=36.7% of the maximum voltage, which corresponds to the discharge time.

The power of the used glasses should rigorously be the same so as to make a comparison possible between the various glass performances, since the values measured by the apparatus depend on the glass geometry.

In the context of the present patent application, by definition, a glass is considered as being antistatic if the discharge time thereof is less than 200 milliseconds.

### b) Evaluation of the Fringe Level

The evaluation of the interference fringe level is visual.
Ophthalmic lenses typically have a power of −4.00.
The observation of ophthalmic lenses is carried out in reflection using Waldman lighting. Lenses should be oriented in such a way that the fringes are perpendicular to the fluorescent lamp. Comparison is effected using as a reference lens, a similar lens except that the lens does not comprise any anti-fringe layer of the invention. (See table 4).

### c) Reflection

Optical reflection measurements Rm and Rv as defined in standard ISO 13666-98 and measured according to standard IS08980-4 have been performed on the −4.00 lenses convex face (measurement on just one face).
For each thickness of the antistatic layer, measurements were effected on three lenses.
For each lens, two measurements were effected at 15 mm from the edge of the lens.
The results correspond to measure averages.

### 2) Used Materials

The used colloids are as follows:

a) ITO colloid provided by CCIC: ELCOM NE-10011TV® (20% by weight). ITO particles have a refractive index of 1.95 and a density of 8.7.
b) Silica colloid provided by DUPONT de NEMOURS: LUDOX® CL-P (40% by weight). Silica particles have a refractive index of 1.48 and a density of 2.4.
c) Hollow SiO₂ colloid provided by CCIC: Thrulya-200W (20% by weight). This suspension is preferably filtered to 5 micrometers before use. Hollow silica particles have a refractive index of 1.35 and a density of 1.2.

### 3) Preparation of Intermediate Layer Compositions

The three following intermediate layer compositions have been prepared:

| | Compo- | Compo- | Compo- |
|---|---|---|---|
| Component | sition 1 | sition 2 | sition 3 |
| SiO₂ colloid | 14.4 g | 19.2 g | — |
| Hollow SiO₂ colloid | — | — | 14.4 g |
| ITO colloid | 67.2 g | 57.6 g | 67.2 g |
| Ethanol | 518.4 g | 523.2 g | 518.4 g |
| Total | 600 g | 600 g | 600 g |
| Solids content (by weight) | 3.2% | 3.2% | 2.8% |
| ITO/SiO₂ Weight ratio (*) | 70/30 | 60/40 | 82/18 |

(*) Dry particles.

First, the silica colloid or the hollow silica colloid was combined with part of the ethanol for 20 minutes, then the ITO colloid was added as well as the residual ethanol. The mixture was then stirred for further 20 minutes. The resulting compositions were not filtered and were stored in the refrigerator. The various components were mixed together when they had the same temperature.

### 4) General Procedure for Preparing Antistatic and Anti-Fringe Glasses

It is preferred to deposit the intermediate layer compositions once they have been prepared. If these preparations are stored, a phase separation may occur. If so, the compositions prior to depositing should be stirred for 30 minutes so as to become homogeneous again. To obtain the best possible deposition, it is recommended to work under moisture regulated conditions.

The three intermediate layer compositions were deposited by dip coating at various rates, ranging from 4.7 cm/mn up to the maximum rate of 28.5 cm/mn. For the same intermediate layer composition, a high deposition rate leads to a thicker and more porous layer. Without wishing to be bound by any limitating interpretation of the invention, the applicant thinks that a slow dewetting rate produces a more compact stack of the colloids, the latter having more time to stack before evaporation of the solvent.

Depositions were carried out on the convex and concave sides by dip coating thermosetting polythiourethane substrates (ophthalmic lenses), said substrates being marketed by the MITSUI company and having a refractive index of 1.6 (example 3) or 1.67 (examples 1, 2), and having been previously washed. Each deposition procedure was effected on a series of 6 lenses (3 +4,00 lenses and 3 −4,00 lenses).

The lenses were then dried under ambient air and room temperature conditions for 4 minutes. The thickness and the refractive index of the colloid layer deposited and dried (porous layer) were then determined by means of the RMS (reflection measuring system) and the measured values are given in the following tables.

After drying and cooling, the colloid layer was coated by dip coating an impact-resistant primer layer based on a polyurethane latex comprising polyester units (Witcobond® 234 from BAXENDEN CHEMICALS). Said layer is pre-polymerized for 15 min at 75° C., leading to a coating with a refractive index of 1.50. Although a low swelling of the colloid-based intermediate layer may occur, it was observed that the thickness thereof did not vary much because of the Witcobond® 234 latex diffusion.

Lastly, the anti-abrasion and scratch-resistant coating (hard coat) disclosed in example 3 of the patent EP 0614957 (with a refractive index of 1.50), based on a GLYMO and DMDES hydrolyzate, on colloidal silica and aluminium acetylacetonate was deposited by dip coating onto the primer coating, then prepolymerized at 75° C. for 15 minutes. Lastly, the complete stack did undergo a polymerization for 3 hours at 100 ° C.

The discharge time of the coated convex side and the transmission of the final optical article were measured. The results are given in the following tables, the articles which were not made according to the invention being indicated through dimmed lines.

### 5) Examples 1 and 2

The intermediate layer is formed between a substrate with a refractive index of 1.67 and a primer coating with a refractive index of 1.50. The theoretical characteristics of a quarter-wave layer are as follows:

$$n = \sqrt{1.67 \times 1.5} = 1.5827 ; e = \frac{550}{4 \times 1.5847} = 86.9 nm$$

### Results for Example 1 (Intermediate Layer Composition 1)

TABLE 1

| | | | Intermediate | | | | |
|---|---|---|---|---|---|---|---|
| | | | layer (after | | | | |
| Dried colloid layer before | | | filling porosity | Optical article properties | | | |
| latex diffusion | | | with the primer) | Trans- | Rt/Rm | | |
| Thickness | Refractive | Calculated | Theoretical | mission | (1 side) | Discharge | Fringe |
| (nm) | index n₁ | porosity | refractive index | (%) | (%) | time (ms) | level |
| [symbol] | [symbol] | [symbol] | [symbol] | [symbol] | [symbol] | [symbol] | [symbol] |
| 63.9 | 1.409 | 0.38 | 1.60 | 91.2 | 3.80/3.84 | 151 | NE |
| 78.8 | 1/365 | 0.45 | 1.59 | 91.2 | 3.39/3.40 | 25 | -- |
| 92.4 | 1.35 | 0.47 | 1.58 | 91.6 | 3.60/3.63 | 28 | - |
| 106 | 1.344 | 0.48 | 1.58 | 91.2 | 3.40/3.43 | 29 | - |

-: low level as compared to reference (Ref2)
--: very low level as compared to reference (Ref2)
NE: non evaluated

The initial porosity p of the dried colloid layer given in tables 1-3 was calculated from the refractive index value of this porous layer (n₁, value measured using the RMS) and from the mean refractive index of the backbone of this layer (n₂, value calculated for a material assumed to be dense, that is to say with no accessible pores) by means of the following formula (linear approximation):

n₁=p+n₂×(1−p)

The mean refractive index n₂ of the porous colloid layer backbone is calculated by means of the following formula, applicable to a SiO₂/ITO binary backbone:

$${n}_{2} = \frac{{X}_{m}^{{SiO}_{2}} \times {ρ}^{ITO} \times {n}_{{SiO}_{2}}}{{ρ}^{{SiO}_{2}} + {X}_{m}^{{SiO}_{2}} \times ( {ρ}^{ITO} - {ρ}^{{SiO}_{2}} )} + \frac{{X}_{m}^{ITO} \times {ρ}^{{SiO}_{2}} \times {n}_{ITO}}{{ρ}^{ITO} + {X}_{m}^{ITO} \times ( {ρ}^{{SiO}_{2}} - {ρ}^{ITO} )}$$

wherein Xₘ^{SiO2} represents the weight proportion of silica particles relative to the porous layer particle total weight, Xₘ^{ITO} the weight proportion of ITO particles relative to the porous layer particle total weight (here Xₘ^{SiO2}+Xₘ^{ITO}=1) ρ^{SiO2} the density of the silica particles, ρ^{ITO} the density of the ITO particles, n_{SiO2} the refractive index of the silica particles, n_{ITO} the refractive index of the ITO particles.

The theoretical refractive index n₃ of the intermediate layer corresponds to the refractive index of this layer assuming that the pores thereof have been totally filled with the material of the impact-resistant primer composition. It is calculated by means of the following formula (linear approximation):

n₃=ₚᵣᵢₘₑᵣp×n+n₂×(1−p)

wherein p (porosity prior to filling) and n₂ have the same meaning as previously and nₚᵣᵢₘₑᵣ is the refractive index of the primer layer (1.5).
In this calculation, one assumes that the filling is not performed in the hollow or porous colloids (colloid pores are not accessible to the filling material).

Results for Example 2 (Intermediate Layer Composition 2)

TABLE 2

| | | | Intermediate | | | | |
|---|---|---|---|---|---|---|---|
| | | | layer (after | | | | |
| Dried colloid layer, before | | | filling of the | Properties of the optical article | | | |
| diffusion of the latex | | | pores with primer) | Trans- | Rv/Rm | | |
| Thickness | Refractive | Calc. | Theoretical | mission | (%) | Discharge | Fringe |
| (nm) | index n₁ | porosity | refractive index | (%) | (1 side) | time (ms) | level |
| 52 | 1.493 | 0.20 | 1.594 | 91.6 | 3.88/3.9 | 27250 | NE |
| 61 | 1.403 | 0.35 | 1.577 | 91.2 | 3.82/3.84 | 7255 | NE |
| 75 | 1.383 | 0.38 | 1.573 | 91.6 | 3.78/3.8 | 164 | -- |
| 111.5 | 1.34 | 0.45 | 1.565 | 91.6 | 3.82/3.88 | 175 | NE |
| 115.2 | 1.344 | 0.44 | 1.565 | 91.1 | 4.0/4.0 | 112 | - |

--: low level as compared to reference (Ref2)
-: very low level as compared to reference (Ref2)
NE: non evaluated

### 6) Example 3

The intermediate layer is formed between a substrate with a refractive index of 1.6 and a primer coating with a refractive index of 1.50. The theoretical characteristics of a quarter-wave layer are thus as follows:

$$n = \sqrt{1.6 \times 1.5} = 1.5492 ; e = \frac{550}{4 \times 1.5492} = 88.76 nm$$

### Results for Example 3 (Intermediate Layer Composition 3)

TABLE 3

| | | | Intermediate | | | | |
|---|---|---|---|---|---|---|---|
| | | | layer (after | | | | |
| Dried colloid layer, before | | | filling of the | Properties of the optical article | | | |
| diffusion of the latex | | | pores with the primer) | Trans- | Rv/Rm | | |
| Thickness | Refractive | Calc. | Theoretical | mission | (%) | Discharge | Fringe |
| (nm) | index n₁ | porosity | refractive index | (%) | (1 side) | time (ms) | level |
| 52.2 | 1.484 | 0.17 | 1.570 | 92 | 3.86/3.88 | 24500 | - |
| 52.9 | 1.465 | 0.20 | 1.567 | 92.3 | 3.91/3.93 | 2809 | NE |
| 65 | 1.45 | 0.23 | 1.565 | 92.2 | 3.81/3.83 | 27 | -- |
| 97.6 | 1.364 | 0.38 | 1.553 | 91.8 | 3.82/3.88 | 24 | -- |
| 100 | 1.371 | 0.37 | 1.554 | 92.2 | 4.0/4.0 | 64 | NE |

-: low level as compared to reference (Ref1)
--: very low level as compared to reference (Ref1)
NE: non evaluated

### 7) Comparative Examples

Properties of glasses similar to those prepared in examples 1-3 but with no intermediate layer between the substrate and the primer coating have also been evaluated. Two series have been prepared, depending on the refractive index of the substrate (1.67: comparative example 1; 1.6: comparative example 2).

### Results for Comparative Examples (No Intermediate Layer)

TABLE 4

| | Reflection Rm | Discharge | Fringe |
|---|---|---|---|
| | (per side) (%) | time (ms) | level |
| Lens Ref1 (such as prepared in | 4.5 | >30000 | Very |
| 4) (substrate with index 1.6 + | | | high |
| primer with index 1.5 + hard | | | |
| coat varnish with index 1.5) | | | |
| Lens Ref2 such as prepared in | 4 | >30000 | Very |
| 4) (substrate with index 1.67 + | | | high |
| primer with index 1.5 + hard | | | |
| coat varnish with index 1.5) | | | |

### Comments About the Results Obtained

Tables 1 to 3 provide several examples of optical articles possessing an intermediate layer and having simultaneously antistatic properties (discharge time less than 200 ms) and capable of significantly limiting the perception of interference fringes.

A comparison with the comparative tests, which used stacks with no intermediate layer according to the invention, reveals that the interference fringe intensity is significantly reduced thanks to the presence of this layer.

In Tables 1-3, tests obtaining the minimal fringe level are indicated in bold. It logically appears that the best results as to the reduction of the interference fringe perception are obtained with the intermediate layers having the thickness and refractive index characteristics coming the closest to the theoretical characteristics of a quarter-wave layer.

The transmission values obtained are systematically higher than 91%, and on average higher than 91.5%.

For lenses with a refractive index ranging from 1.6 to 1.67, with a coating refractive index of about 1.50, reflection levels Rm of lenses according to the invention may decrease by a maximum value of about 0.6% per side, which represents an improvement (i.e. a reduction) of the reflection level of about 1.2% for both sides, enabling a transmission gain of approximately 1.2% as compared with to the same lens with no quarter-wave layer.

It should be noted that an intermediate antistatic quarter-wave layer or almost quarter-wave layer cannot be obtained with the system of example 3 (substrate with a refractive index of 1.6/primer with a refractive index of 1.5) if using a SiO₂/ITO mixture. Indeed, quarter-wave or almost quarter-wave layers resulting from the use of such colloid system do not offer sufficient antistatic properties, as opposed to quarter-wave or almost quarter-wave layers resulting from the use of a hollow SiO₂ /ITO colloid system.

Lastly, tests carried out reveal that for a given intermediate layer composition, discharge times may be divided by 1000 when the thickness of the intermediate layer is multiplied by 2 and that the porosity of the layer is simultaneously also multiplied by 2 (cf. Table 3). A calculation makes it possible to show that the amount of effectively deposited ITO particles has been increased by about 50% between first and last test in Table 3.

1.-19. (canceled)

20. An optical article comprising an organic or mineral glass substrate and a layer of a polymeric material, comprising an intermediate layer having antistatic properties in direct contact with a main face of the substrate and the layer of polymeric material, the intermediate layer comprising a mixture of colloidal particles of at least one electrically conductive, colloidal metal oxide, of colloidal particles of non-conductive mineral oxides having a refractive index of 1.55 or less, in such proportions that the mass of electrically conductive colloidal metal oxide particles represents 50 to 97% of the total weight of colloidal particles present in the intermediate layer, said intermediate layer being an initially porous layer, the pores of which have been filled either with material of the layer of polymeric material or with material of the substrate if the latter is made of an organic glass, so that the intermediate layer, after the initial porosity thereof has been filled, verifies the characteristics given by the following relationships:
$$\begin{matrix}0.725 \times \frac{λ}{4 n} \leq e \leq 1.35 \times \frac{λ}{4 n} & ( 1 ) \\ 0.98 \times \sqrt{{n}_{substrate} \cdot {n}_{polymer}} \leq n \leq 1.02 \times \sqrt{{n}_{substrate} \cdot {n}_{polymer}} & ( 2 )\end{matrix}$$
wherein n is the refractive index of the intermediate layer, n_{substrate} is the refractive index of the substrate, n_{polymer} is the refractive index of the layer of polymeric material in direct contact with the intermediate layer, e is the thickness of the intermediate layer and λ is set at 550 nm.

21. The optical article of claim 20, wherein the weight of electrically conductive colloidal metal oxide particles represents 50 to 95% of the total weight of colloidal particles present in the intermediate layer.

22. The optical article of claim 21, wherein the weight of electrically conductive colloidal metal oxide particles represents 60 to 90% of the total weight of colloidal particles present in the intermediate layer.

23. The optical article of claim 20, further comprising an intermediate layer verifying the following equation:
$$0.8 \times \frac{λ}{4 n} \leq e \leq 1.2 \times \frac{λ}{4 n} . \qquad ( {1}^{′} )$$

24. The optical article of claim 20, further comprising an intermediate layer verifying the following equation:
0.985×\sqrt{n_{substrate}·n_{polymer}}≦n≦1.105×\sqrt{n_{substrate}·n_{polymer}} (2′).

25. The optical article of claim 20, further comprising an intermediate layer with a porosity of less than 20% by volume.

26. The optical article of claim 20, further comprising an intermediate layer, the thickness of which ranges from 60 to 130 nm.

27. The optical article of claim 20, wherein the colloidal particle size varies from 10 to 80 nm.

28. The optical article of claim 20, wherein the electrically conductive, colloidal metal oxide is tin-doped indium oxide, antimony-doped tin oxide, tin oxide, zinc oxide, indium oxide, vanadium pentoxide, aluminum-doped zinc oxide, cerium oxide, zinc antimonate, indium antimonite or antimony oxide.

29. The optical article of claim 20, wherein the colloidal mineral oxide having a refractive index of 1.55 or less is silica, silica doped with alumina or porous or hollow mineral oxide.

30. The optical article of claim 29, wherein the colloidal mineral oxide having a refractive index of 1.55 or less is a porous or hollow mineral oxide having a refractive index ranging from 1.15 to 1.40.

31. The optical article of claim 20, which has a light transmittance factor in the visible range (Tv) higher than 91%.

32. The optical article of claim 20, wherein the layer of polymeric material in direct contact with the intermediate layer is a layer of an adhesion and/or impact-resistant primer coating, a layer of an anti-abrasion and/or scratch-resistant coating, a layer of an anti-reflection coating or a layer of an adhesive composition.

33. The optical article of claim 20, wherein the porosity of the intermediate layer is filled with the polymeric material of a layer of an adhesion and/or impact-resistant primer coating.

34. The optical article of claim 20, wherein the substrate is an ophthalmic lens.

35. The optical article of claim 20, wherein the refractive index difference between the substrate and the layer of polymeric material is of 0.01 or more.

36. The optical article of claim 35, wherein the refractive index difference between the substrate and the layer of polymeric material is of 0.02 or more.

37. The optical article of claim 36, wherein the refractive index difference between the substrate and the layer of polymeric material is of 0.05 or more.

38. The optical article of claim 37, wherein the refractive index difference between the substrate and the layer of polymeric material is of 0.1 or more.

39. A method of manufacturing an optical article of claim 20, comprising:
a) depositing a layer of an intermediate layer composition on at least one main surface of an organic or mineral glass substrate or on a layer of a polymeric material, said composition comprising a mixture of colloidal particles of at least one electrically conductive, colloidal metal oxide, or colloidal particles of non-conductive mineral oxides having a refractive index of 1.55 or less;
b) drying the intermediate layer composition so as to form an initially porous intermediate layer;
c) forming onto this porous intermediate layer either a layer of a polymeric material or an organic glass substrate, so that the initial porosity of the intermediate layer be filled either with material of the polymeric layer or with material of the substrate if the latter is made of an organic glass, and so that the intermediate layer, after the initial porosity thereof has been filled, verifies equations (1) and (2) of claim 20; and
d) recovering an optical article comprising an intermediate layer having antistatic properties in direct contact with a main surface of the substrate and the layer of polymeric material, the weight of electrically conductive colloidal metal oxide particles representing 50 to 97% of the total weight of colloidal particles present in the intermediate layer.

40. The method of claim 39, wherein the layer obtained in step b) has a porosity of at least 20% by volume.

41. The method of claim 39, wherein the layer of intermediate layer composition is deposited onto at least one main face of an organic or mineral glass substrate during step a) and a layer of a polymeric material is formed onto the porous intermediate layer by dip coating or spin coating during step c).
